(19) United States
(12) Patent Application Publication
(10) Pub. No.: US 2009/0173201 A1
(43) Pub. Date: Jul. 9, 2009

(54) FOOD PRODUCT SLICER WITH KNIFE LOAD BASED ASSISTANCE FOR MOVEMENT OF FOOD PRODUCT CARRIAGE

(76) Inventors: Guangshan Zhu, Richmond Hill, GA (US); Samuel A. Rummel, Pooler, GA (US); Raymond A. Carr, Lutz, FL (US)

Correspondence Address: THOMPSON HINE LLP;Intellectual Property Group, P.O Box 8801, DAYTON, OH, 45401-8801, US

(21) Appl. No.: 12/343,541

(22) Filed: Dec. 24, 2008

Related U.S. Application Data
(60) Provisional application No. 61/017,063, filed on Dec. 27, 2007.
(60) Provisional application No. 61/085,139, filed on Jul. 31, 2008.

(51) Int. Cl. B23D 33/02; B26D 7/27

(52) U.S. Cl. 83/474; 83/522.13

(57) ABSTRACT

A food product slicer includes a base and a knife mounted for rotation relative to the base via a knife drive motor. A carriage assembly is mounted to the base for reciprocal movement back and forth past a cutting edge of the knife via a carriage drive motor. An adjustable gauge plate is provided. During a manual assist slicing operation a level of assistance provided by the carriage drive motor varies according to loading on the knife motor.

### CROSS-REFERENCES

This application claims the benefit of provisional application Ser. No 61/085,139, filed Jul. 31, 2008 and Ser. No. 61/017,063, filed Dec. 27, 2007, the entirety of each of which is hereby incorporated by reference.

### TECHNICAL FIELD

This application relates generally to food product slicers of the type commonly used to slice bulk food products and, more specifically, to a food product slicer with an assist feature.

### BACKGROUND

Typical reciprocating food slicers have a rotatable, circular or disc-like slicing blade, an adjustable gauge plate for determining the thickness of the slice and a carriage for supporting the food as it is moved back and forth past the cutting edge of the knife during slicing. A drive motor is typically linked to drive the carriage back and forth during an automatic slicing operation carried out by a controller of the slicer. The gauge plate is situated along the edge of the knife toward the front of a slicing stroke and is laterally movable with respect to the knife for determining the thickness of the slices to be cut. Many slicers also include a manual only mode, in which operator applied manual force, not the drive motor, causes the carriage to move back and forth for slicing. PCT International Application No. PCT/US2006/030066, published as WO 2007/021543, describes a slicer that includes a manual assist operation in which the carriage drive motor provides a level of assistance to the operator dependent upon a sensor (e.g., a force sensor) that detects force applied by the operator.

It would be desirable to provide a food product slicer with an assist function that is better adapted to provide a suitable level of assistance when needed.

### SUMMARY

In one aspect, a food product slicer includes a base and a knife mounted for rotation relative to the base via a knife drive motor. A carriage assembly is mounted to the base for reciprocal movement back and forth past a cutting edge of the knife via a carriage drive motor. An adjustable gauge plate is provided. During a manual assist slicing operation a level of assistance provided by the carriage drive motor varies according to loading on the knife motor.

### BRIEF DESCRIPTION OF DRAWINGS

FIG. 1 is a right side elevation of a slicer;

FIG. 2 is a perspective view of a gauge plate system; and

FIG. 3 is a schematic depiction of a slicer control system.

FIG. 4 is an exemplary graph of slicer knife motor current;

FIG. 5 is an exemplary graph of carriage drive motor torque or force applied during a manual assist mode of the slicer;

FIG. 6 is another exemplary graph of carriage drive motor torque or force applied during a manual assist mode of the slicer; and

FIG. 7 is an exemplary graph of assistance verses carriage position.

### DETAILED DESCRIPTION

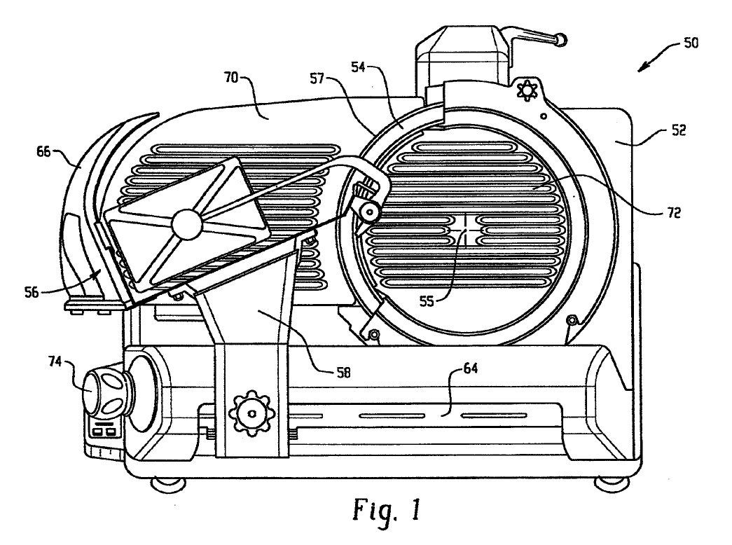

Referring to FIG. 1, a food product slicer 50 includes a housing or base 52 and a circular, motor-driven slicing knife 54 that is mounted to the housing for rotation about an axis 55. The left side of FIG. 1 is generally referred to as the front side of the slicer (which is where an operator stands for slicing), the right side of FIG. 1 is generally referred to as the rear side of the slicer and FIG. 1 depicts a right side view of the slicer. A food product can be supported on a manually operable food carriage 56 which moves the food product to be sliced past the cutting edge 57 of the rotating slicing knife 54. The food carriage 56 reciprocates from left to right relative to FIG. 1, along a linear path so that the lower end of the bulk food product slides along the surface of the gauge plate 70, is cut by the knife 54 and then slides along a knife cover plate 72. Food carriage 56 includes a tray mounted on a tray arm 58 that orients the food carriage tray at the appropriate angle (typically perpendicular) to the cutting edge plane. The food carriage reciprocates in a slot 64 at a lower portion of the housing 52 and a handle 66 is mounted to the food carriage 56. The handle is graspable by a user and can be used to manually move the food carriage in a manual only mode. The carriage may also be automatically driven (e.g., as by a motor drive or other prime mover) in an automatic mode. A manual assist mode is also provided as will be described in greater detail below. In another implementation the manual only mode may be eliminated such that automatic or manual assist are the available modes for slicing. A handle or knob 74 for adjusting the gauge plate to control slice thickness is also shown.

The illustrated position of the food carriage 56 is the most forward or front position relative to the slicer knife 54, typically the starting position for a slicing stroke. This position is also sometimes referred to as the home position of the carriage.

Repeatability of slice thickness is the control of slice thickness within a similar product, for example, if a particular machine slices ham at index setting of 4, on the adjustment knob, and that thickness is desirable, the next time a customer comes back to have more ham sliced and that if the index is set on 4 it will cut the same thickness. This theory will also apply from machine to machine repeatability. Prior techniques provided repeatability within a certain degree but not as consistent as desired. The machine to machine repeatability was generally not present.

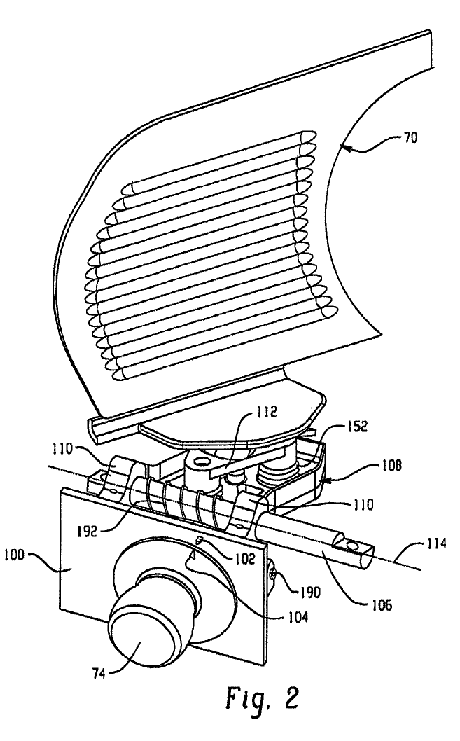

Referring to FIG. 2, where a portion of the slicer housing is shown as 100, a gauge plate system includes rotatable handle assembly with handle 74. The housing 100 includes a zero position indicant 102 and the handle assembly includes a corresponding zero position indicant 104. Though not shown, the handle assembly will typically include other thickness indicants, such a visible numbers and/or a series of hash marks etc. to which an operator can refer when selecting a desired slice thickness. Internal of the slicer a slide rod 106 is fixed to the slicer base (e.g., by fasteners through end openings of the slide rod). An index slider 108 includes mount brackets 110 with openings therethrough enabling the index slider to move along the length of the slide rod 106. The gauge plate 70 is connected to the index slider 108 via an intermediate plate 112. In normal slicer operation the position of the intermediate plate 112 relative to the index slider 108 is fixed. The handle 74 is linked with the index slider 108 such that rotation of the handle 74 causes the index slider to move axially along the slide rod 106. The axis 114 of the slide rod is arranged such that movement of the index slider 108 causes the plane of the gauge plate to move relative to the knife edge cutting plane in a desired manner to adjust slice thickness. Numerous variations for the gauge plate adjustment mechanism exist.

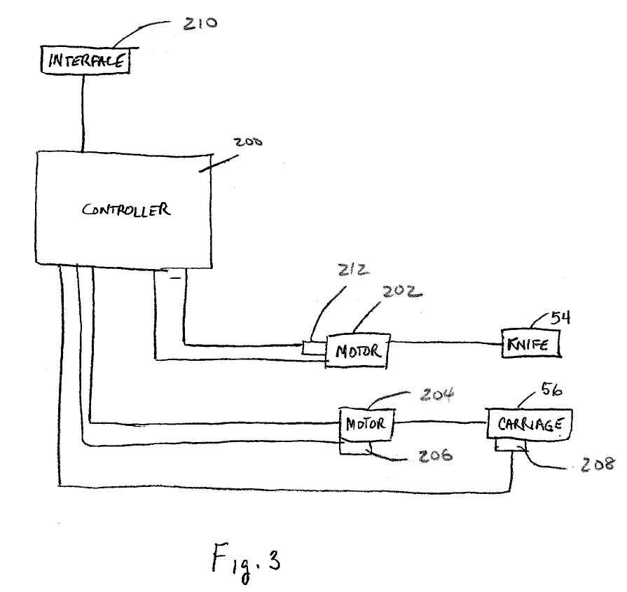

An exemplary slicer control system is illustrated in FIG. 3, and includes a controller 200 (e.g., programmed processor based controller and associated printed circuit board), a slicer knife motor 202, a carriage drive motor 204 and associated position sensing system 206. In one embodiment the carriage drive motor 204 may be a linear motor with one part connected directly to the carriage (as described in PCT International Application No. PCT/US2006/025344, published as WO 2007/002819), and the sensing system 206 may be a linear encoder arrangement and/or one or more position switches such as end of stroke and start of stroke switches. Back EMF produced in the coils of the linear motor may also be used to determine carriage position. In another embodiment the carriage drive motor 204 may be a rotary motor linked to the carriage through a belt or multi-linkage drive system, and the encoder arrangement 206 may be a rotary encoder. Other carriage drive systems are contemplated, including those that directly monitor carriage position through a suitable sensor arrangement 208.

The slicer may include both automatic and manual modes. During automatic slicing, the drive motor 204 moves the carriage back and forth past the slicer knife to repeatedly slice food product loaded on the carriage, with the thickness of slices determined by the open position of the gauge plate. During the manual mode, referred to herein as a manual assist mode, which may be selected by a suitable operator interface, the drive motor 204 is used to provide assistance to the operator as the operator moves the carriage. Specifically, the assistance provided by the drive motor 204 is dependent upon the load on the slicer knife motor 202. In one implementation, the knife motor current is monitored as an indicator of how much assistance to provide (e.g., to determine how much assistance (e.g., linear motor torque or more aptly linear motor force) is desirable to move the food carriage when actually slicing food product). This technique is truly an adaptive automatic assist to manual slicing. In another implementation some type of direct load sensor 212 associated with the knife motor (or alternatively the knife) could be used. In any case, the assistance level can be varied by, for example, varying the energization level and/or duration of motor coils associated with drive motor 204.

In one implementation, a two component assistance system is utilized to achieve a final or total assistance level provided by the drive motor 204. The first assistance component, also referred to as the baseline assistance torque or baseline assistance force, may be a fixed level of assistance and the second level provided by applying a set amount of current to the carriage drive motor 204. The set level may be provided in accordance with the weight of the carriage and the frictional force that resists movement of the carriage. In one variation the set level is the level of drive motor energization that falls just below a level required to cause the empty and stationary food product carriage to begin moving (e.g., as may be determined by testing or calculation). A set amount of motor torque or force is thus applied in the direction of travel (e.g., by first detecting movement direction of the carriage and then beginning to apply current to the drive motor in accordance with the first, fixed level). The amount of additional torque or force (herein referred to as load based torque or load based force) applied to the baseline assistance torque or force is determined by the loading on the knife motor 202, which may be represented by the amount of increased current usage by the knife motor as food product is being sliced (during front to rear carriage movement, i.e. a slicing stroke of the carriage) and the amount of force being applied to the surface of the knife by the food product passing over the knife (during rear to front carriage movement, i.e., a return stroke of the carriage).

FIG. 4 illustrates knife motor current draw during carriage movement and food product slicing. The nominal current draw on the knife motor is I_{N}, which is the current draw when the knife is not loaded by the food product. As the food product moves into engagement with the knife during a slicing stroke, the current draw increases, peaks, then decreases back to the nominal level once the interaction between the food product and the knife has stopped, as indicated by period P1. The carriage then reaches the end of the slicing stroke and begins movement back in the opposite direction for the return stroke, during which time the food product is not interacting with the slicer knife, as indicated by period P2. During the return stroke the food product slides over the moving surface of the knife causing increased knife loading per the increase, peak and decrease in current draw indicated by period P3. The current draw on the knife then remains around nominal as the carriage moves back to the front or home of the stroke, changes direction and moves back toward the knife until the food product again comes into slicing contact with the knife edge, at which point the cycle will then repeat. Thus, FIG. 4 demonstrates that the important periods for providing additional carriage drive motor torque or force are periods P1 and P3.

In one implementation, the slicer control monitors the knife current draw and provides additional carriage drive motor current at a level proportional to the difference between the actual knife current draw and the nominal knife current (I_{ACTUAL}−I_{N}), so long as the difference is a positive value. In one variation the additional drive motor current may be directly proportional to the difference, but other variations are possible. In another implementation, the additional torque or force or load based torque or force is only applied once the knife motor current draw reaches a set level above the nominal level (e.g., at least a level reflected by current I_{X}).

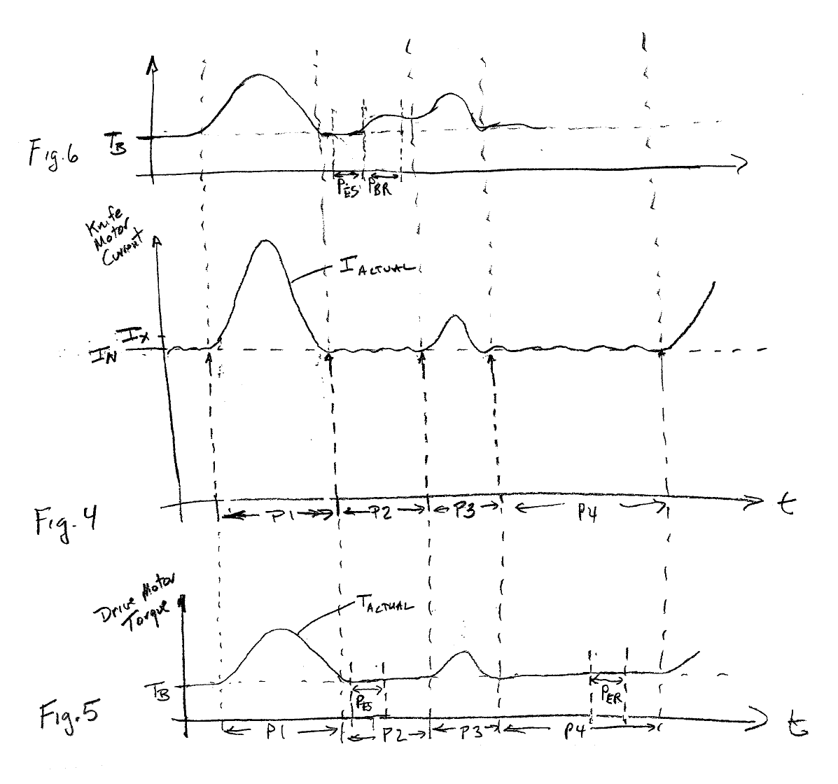

FIG. 5 illustrates an exemplary graph of actual carriage drive motor torque provided for the two component assistance embodiment, showing the total torque is always at least at the baseline assistance torque T_{B} and that the variation in additional torque corresponds to the increase in knife motor loading. However, it is recognized that variations are possible. Specifically, near the end of the slicing stroke (during period P_{ES}) and during the end of the return stroke (during period P_{ER}) it may be desirable to eliminate (e.g., by ramping down) all applied torque level of the carriage drive motor, particularly where the carriage drive motor is a linear motor and it is necessary to change the energization sequence of the linear motor in order to reverse direction. During such turnaround periods, the motor back-EMF helps to dampen the turnaround and opposes any continued motion at the end of the stroke. The food product tray is then pulled (or pushed) with minimal effort in the opposite direction and the slicer control detects the direction reversal and initiates carriage drive motor current being applied in that direction at a level to provide the baseline torque assistance T_{B}. In another implementation, the slicer control could treat the entirety of periods P2 and P4 as periods corresponding to end of stroke and turnaround, with no carriage drive motor torque being applied during those periods. In FIG. 5 the torque assistance can also be representative more generally as the force assistance provided to move the carriage.

While a two component assistance system is primarily described, it is recognized that a single component assistance system is also possible (e.g., one where carriage drive motor torque level does not include a baseline torque assistance component).

The described manual assist system is responsive to the type of food product being sliced (e.g., a cheese product will cause greater knife loading than a soft tomato) and is also responsive to operator action (e.g., the harder the operator attempts to move the food product past the slicer knife during slicing, the greater the knife loading). Accordingly, the contemplated manual assist feature is truly adaptive to the actual slicing conditions.

In one implementation of the manual assist, the carriage drive motor is not energized unless and until the knife drive motor is operating.

Referring back to FIG. 4, in some instances, voltage may vary for a given rated voltage level from one geographical location to another. These variations in voltage from one region to another can affect a baseline current draw of the knife motor 202. These variations are accounted for by monitoring the knife motor current (e.g., using controller 200) right at startup of the food product slicer 50 and adjusting the baseline torque assistance with a calculated offset, which offset accounts for the difference between the actual nominal voltage seen by the slicer and the assumed nominal voltage used to define the baseline torque assistance during slicer design and manufacture. This arrangement provides a system and method of providing baseline compensation for variances in line voltages and motors so that an operator experiences the same assistance for a given product and weight throughout the day regardless of voltage variations in the line and regardless of location of use. In some embodiments, line voltage is monitored electronically to establish a baseline torque assistance compensation/offset.

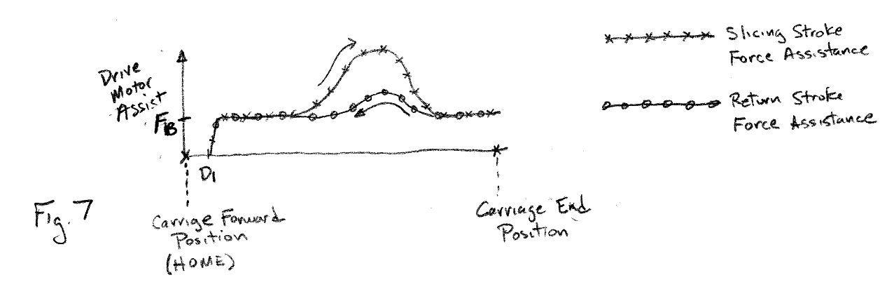

In some embodiments, assistance on product cut-through turnaround is provided. An amount of assistance is provided to an operator to aid in reversing directions of the carriage 56 after the product is cut through at the end of carriage travel. The amount of assistance is determined by the increase in current sensed when moving the product over the knife 54 on the previous return portion of a product slicing cycle. In other words, the turnaround torque or force assistance for given carriage movement cycle (shown in FIG. 6 during period P_{BR}) is determined based upon the actual knife current/load from period P3 of the return stroke of the immediately preceding carriage movement cycle. The turnaround return assistance (e.g., during period P_{BR}) is then blended into the assistance determined during period P3 of the current return stroke. Though not shown in FIG. 6, the torque or force assistance during period P_{ES} could be dropped to zero, or some other level below the baseline T_{B}, to facilitate the turnaround process.

As mentioned above, in some embodiments the assistance could be dropped to zero near the end of the slicing stroke and/or near the end of the return stroke. Referring to FIG. 7, an embodiment is shown in which the assistance is dropped to zero whenever the carriage is at or near the most forward or home position, which position may be sensed via the linear encoder mentioned above, via a specific carriage sensor located proximate the home position and/or by other suitable sensing arrangements. The assistance may be maintained at zero provided the carriage location is within a set distance D1 (e.g., about 1 inch or less) of the home position.

In one example, when the carriage is determined to be outside of this home region (defined by distance D1), at least a baseline assistance F_{B} may be automatically applied at all times. Thus, in a typical manual assist slicing operation starting from the home position of the carriage with the carriage moving away from the home position, assistance is zero for a set distance D1, assistance is raised to a baseline assistance level F_{B} for a distance until a knife motor load increase is detected, at which point the additional knife load based assistance is applied until the food product has passed by the knife and the knife motor load again settles to nominal, at which point the baseline assistance alone is again applied.

In another example, even outside of the home region, the baseline assistance may be applied only when a determination is made that the speed of the carriage has reached a threshold minimum level. In this latter example, the assistance is set to zero both (i) whenever the carriage is determined to be within the home region (defined by distance D1) and (ii) whenever the carriage is moving at a speed that is below a threshold minimum speed.

Either of the two immediately preceding examples, could be adapted to include an end of slicing stroke turnaround assistance feature a previously described. Moreover, when the carriage is in the home region the carriage motor could also be energized in a manner tending to hold the carriage in the home region (e.g., resisting movement of the carriage). In the case of linear motor drive carriage this carriage hold feature could be achieved by applying a constant energization level to certain coils associated with the linear motor.

It is to be clearly understood that the above description is intended by way of illustration and example only and is not intended to be taken by way of limitation. Variations are possible.

What is claimed is:

1. A food product slicer, comprising:
a base;
a knife mounted for rotation relative to the base;
a carriage mounted to the base for reciprocal movement back and forth past a cutting edge of the knife via a carriage drive;
an adjustable gauge plate mounted for movement to vary slicing thickness;
a carriage control associated with the carriage drive and configured such that during a manual assist slicing operation a level of assistance provided by the carriage drive varies according to loading on the knife.

2. The food product slicer of claim 1 wherein the knife is driven by a knife motor and loading on the knife is detected by monitoring loading on the knife motor.

3. The food product slicer of claim 2 wherein loading on the knife motor is detected by monitoring current draw of the knife motor.

4. The food product slicer of claim 3 wherein loading on the knife motor is detected by monitoring current draw of the knife motor in excess of a set nominal current draw of the knife motor.

5. The food product slicer of claim 1 wherein the level of assistance is increased as loading on the knife increases.

6. The food product slicer of claim 5 wherein the carriage control is configured to implement at least a two stage assistance methodology, including applying a baseline assistance when knife motor load is below a threshold level and an additional assistance when knife motor load is above the threshold level.

7. The food product slicer of claim 6 wherein at least one sensor is provided for determining when the carriage is in a home position region and the carriage control is configured such that no assistance is provided when the carriage is in the home position region.

8. The food product slicer of claim 7 wherein the carriage control is configured such that a carriage hold energization is applied when the carriage is in the home position region.

9. The food product slicer of claim 7 wherein at least one sensor is provided for determining when the carriage is near an end of slicing stroke position, the carriage control is configured such that a carriage end of slicing stroke turnaround assistance is provided.

10. The food product slicer of claim 9 wherein the carriage end of slicing stroke turnaround assistance is dependent upon loading upon the knife during a prior return stroke movement of the carriage.

11. A food product slicer, comprising:
a base;
a knife mounted for rotation relative to the base via a knife motor;
a carriage mounted to the base for reciprocal movement back and forth past a cutting edge of the knife via a carriage drive motor, the carriage assembly including a tray for supporting food product;
an adjustable gauge plate mounted for movement to vary slicing thickness;
a carriage control associated with the carriage drive motor and configured such that an energization level of the carriage drive motor is varied according to loading on the knife motor.

12. The food product slicer of claim 11 wherein loading on the knife motor is detected by monitoring current draw of the knife motor.

13. The food product slicer of claim 12 wherein loading on the knife motor is detected by monitoring current draw of the knife motor in excess of a set nominal current draw of the knife motor.

14. The food product slicer of claim 13 wherein the energization level of the carriage drive motor is increased as loading on the knife increases.

15. The food product slicer of claim 14 including at least one sensor for determining carriage position and at least one sensor for determining carriage speed, wherein the carriage control is configured such that energization level of the carriage drive motor is set to substantially zero both (i) whenever the carriage is determined to be near a most forward carriage position and (ii) whenever the carriage is moving at a speed that is below a threshold minimum speed.
